(19) United States
(12) Patent Application Publication
(10) Pub. No.: US 2018/0322842 A1
(43) Pub. Date: Nov. 8, 2018

(54) LIQUID CRYSTAL DISPLAY PANEL AND DEVICE

(71) Applicant: Shenzhen China Star Optoelectronics Semiconductor Display Technology Co., Ltd., Guangdong (CN)

(72) Inventor: Sikun HAO, Guangdong (CN)

(21) Appl. No.: 15/578,019

(22) PCT Filed: Jun. 9, 2017
(86) PCT No.: PCT/CN2017/087792

§ 371 Date: Nov. 29, 2017

(30) Foreign Application Priority Data
May 8, 2017 (CN) 201710318313.5

(51) Int. Cl. G09G 3/36

(52) U.S. Cl. CPC G09G 3/3677; G09G 2300/0426

(57) ABSTRACT

A liquid crystal display panel and device is provided. The liquid crystal display panel includes lines of pixels. The 2k+1 row of pixels of the numbered n pixel group is connected with the corresponding first scanning line. The numbered 2k row of pixels of the numbered n pixel group is connected with the corresponding second scanning line. The 2k+1 row of pixels of the numbered n+1 pixel group is connected with the corresponding second scanning line. The numbered 2k row of pixels of the numbered n pixel group is connected with the corresponding first scanning line.

### FIELD OF THE INVENTION

The present disclosure relates to the field of display technique, and more particularly to a liquid crystal display panel and device.

### BACKGROUND OF THE INVENTION

The liquid crystal display panel is the most popular display panel used in all kinds of electrical devices, such as mobile phones, personal digital accessors (PDA), digital cameras, calculators, and portable computers.

A driving structure of the liquid crystal display panel as used at the present time is shown in FIG. 1. G1-G12 represent scanning lines while D1-D3 represent data lines. The number of scanning lines is twice of the horizontal resolution. Each line of pixels is driven by two scanning lines. The number of data lines is twice of the vertical resolution. Each data line drives left row and right row of pixels beside.

FIG. 2 is the driving clock timing diagram of the liquid crystal display panel of FIG. 1. Data1 represents the practical input voltage of the data line D1. Data2 represents the practical input voltage of the data line D2. Gate1 represents the scanning clock signal of the first scanning line G1. Gate2 represents the scanning clock signal of the second scanning line G2. Gate3 represents the scanning clock signal of the third scanning line G3. Gate4 represents the scanning clock signal of the fourth scanning line G4.

FIG. 3 is the charging efficiency of pixels of the liquid crystal display panel of FIG. 1, wherein L represents low charging efficiency, while H represents high charging efficiency. It is obvious that each data line when the polarity is reversed, the corresponding left side pixels thereof has low charging efficiency, while the corresponding right side pixels thereof has high charging efficiency. Thus the low charging efficiency pixels are in the same row, while the high charging efficiency pixels are in the other same row. This causes adjacent lighter line and darker line in the vertical direction thus negatively affecting the displaying effect.

Therefore, it is needed to provide a new liquid crystal display panel and device to overcome the problem existed in the conventional technologies.

### SUMMARY OF THE INVENTION

An object of the present disclosure is to provide a liquid crystal display panel and device for promoting display effect.

To achieve the above object, the present disclosure provides a a liquid display panel which comprises a plurality of scanning lines, a plurality of data lines, and a plurality of pixels. Each line of pixels is corresponding to a first scanning line and a second scanning line of the scanning lines. Every two rows of pixels are corresponding to one of the data lines. The liquid display panel further comprises N number of pixel groups, each of which comprises at least one line of pixels. The numbered 2k+1 row of pixels of the numbered n pixel group is connected with the corresponding first scanning line. The numbered 2k row of pixels of the numbered n pixel group is connected with the corresponding second scanning line. The numbered 2k+1 row of pixels of the numbered n+1 pixel group is connected with the corresponding second scanning line, The numbered 2k row of pixels of the numbered n pixel group is connected with the corresponding first scanning line, wherein 0<n<N, N [symbol] , k [symbol] . The turn-on time of the first scanning line corresponding to each line of pixels is earlier than the turn-on time of the second scanning line of the line of pixels. The charging efficiency of pixels corresponding to the first scanning line is lower than the charging efficiency of pixels corresponding to the second scanning line. The charging efficiency of numbered n pixel group in each row of pixels is different from the charging efficiency of the numbered n+1 pixel group in said row of pixels.

In embodiments of the present disclosure, the voltage polarities of two adjacent two data lines at the same moment are the same.

In embodiments of the present disclosure, the voltage polarities of two adjacent two data lines at the same moment are different.

In embodiments of the present disclosure, the pixel group comprises two lines of pixels. The numbered 2k+1 row of pixels of the numbered n pixel group is connected with the corresponding first pixel group, The numbered 2k row of pixels of the numbered n pixel group is connected with the corresponding second scanning line. The numbered 2k+1 row of pixels of the numbered n+1 pixel group is connected with the corresponding second scanning line. The numbered 2k row of pixels of the numbered n+1 pixel group is connected with the corresponding first scanning line,

In embodiments of the present disclosure, the pixel group comprises two adjacent lines of pixels.

In embodiments of the present disclosure, the liquid display panel comprises a plurality of scanning lines, a plurality of data lines, and a plurality of pixels. Each line of pixels is corresponding to a first scanning line and a second scanning line of the scanning lines. Every two rows of pixels is corresponding to one of the data lines. The liquid display panel further comprises N number of pixel groups, each of which comprises at least one line of pixels. The numbered 2k+1 row of pixels of the numbered n pixel group is connected with the corresponding first scanning line. The numbered 2k row of pixels of the numbered n pixel group is connected with the corresponding second scanning line. The numbered 2k+1 row of pixels of the numbered n+1 pixel group is connected with the corresponding second scanning line. The numbered 2k row of pixels of the numbered n pixel group is connected with the corresponding first scanning line, wherein 0<n<N, N≥2, k≥0.

In embodiments of the present disclosure, the voltage polarities of two adjacent two data lines at the same moment are the same.

In embodiments of the present disclosure, the voltage polarities of two adjacent two data lines at the same moment are different.

In embodiments of the present disclosure, the charging efficiency of numbered n pixel group in each row of pixels is different from the charging efficiency of numbered n+1 pixel group in said row of pixels.

In embodiments of the present disclosures, the turn-on time of the first scanning line corresponding to each line of pixels is earlier than the turn-on time of the second scanning line of said line of pixels. The charging efficiency of pixels corresponding to the first scanning line is lower than the charging efficiency of pixels corresponding to the second scanning line.

An embodiment of the present disclosure, the pixel group comprises two lines of pixels. The numbered 2k+1 row of pixels of the numbered n pixel group is connected with the corresponding first scanning line. The numbered 2k row of pixels of the numbered n pixel group is connected with the corresponding second scanning line. The numbered 2k+1 row of pixels of the numbered n+1 pixel group is connected with the corresponding second scanning line. The numbered 2k row of pixels of the numbered n pixel group is connected with the corresponding first scanning line.

In embodiments of the present disclosure, the pixel group comprises two adjacent lines of pixels.

In embodiments of the present disclosure, the liquid crystal display device comprises: a backlight module and a liquid crystal display panel which comprises a plurality of scanning lines, a plurality of data lines, and a plurality of pixels. Each line of pixels is corresponding to a first scanning line and a second scanning line of the scanning lines, every two rows of pixels is corresponding to one of the data lines. The liquid display panel further comprises N number of pixel groups, each of which comprises at least one line of pixels. The 2k+1 row of pixels of the numbered n pixel group is connected with the corresponding first scanning line. The numbered 2k row of pixels of the numbered n pixel group is connected with the corresponding second scanning line. The 2k+1 row of pixels of the numbered n+1 pixel group is connected with the corresponding second scanning line. The numbered 2k row of pixels of the numbered n pixel group is connected with the corresponding first scanning line, wherein 0<n<N, N≥2, k≥0.

In embodiments of the present disclosure, the voltage polarities of two adjacent two data lines at the same moment are the same.

In embodiments of the present disclosure, the voltage polarities of two adjacent two data lines at the same moment are different.

In embodiments of the present disclosure, charging efficiency of numbered n pixel group in each row of pixels is different from the charging efficiency of numbered n+1 pixel group in said row of pixels.

In embodiments of the present disclosure, the turn-on time of the first scanning line corresponding to each line of pixels is earlier than the turn-on time of the second scanning line of the line of pixels. The charging efficiency of pixels corresponding to the first scanning line is lower than the charging efficiency of pixels corresponding to the second scanning line.

In embodiments of the present disclosure, the pixel group comprises two lines of pixels. The numbered 2k+1 row of pixels of the numbered n pixel group is connected with the corresponding first scanning line. The numbered 2k row of pixels of the numbered n pixel group is connected with the corresponding second scanning line. The numbered 2k+1 row of pixels of the numbered n+1 pixel group is connected with the corresponding second scanning line. The numbered 2k row of pixels of the numbered n pixel group is connected with the corresponding first scanning line.

In embodiments of the present disclosure, the turn-on time of the first scanning line corresponding to each line of pixels is earlier than the turn-on time of the second scanning line of said line of pixels. The charging efficiency of pixels corresponding to the first scanning line is lower than the charging efficiency of pixels corresponding to the second scanning line.

In embodiments of the present disclosure, the liquid crystal display panel and device comprises a plurality of pixels which are classified into pixel groups, each of which comprises at least one line of pixels. Pixels in the same row of adjacent two pixel groups are connected with scanning lines having different driving time thus causing different charging efficiencies therebetween, preventing lighter and darker lines from generating in the vertical direction, thus promoting displaying effect.

For more clearly and easily understanding above content of the present disclosure, the following text will take a preferred embodiment of the present disclosure with reference to the accompanying drawings for detailed description as follows.

### DESCRIPTION OF THE DRAWINGS

The technical solution, as well as beneficial advantages, of the present disclosure will be apparent from the following detailed description of one or more embodiments of the present disclosure, with reference to the attached drawings. In the drawings:

FIG. 1 is a driving structure of the liquid crystal display panel as used at the present time.

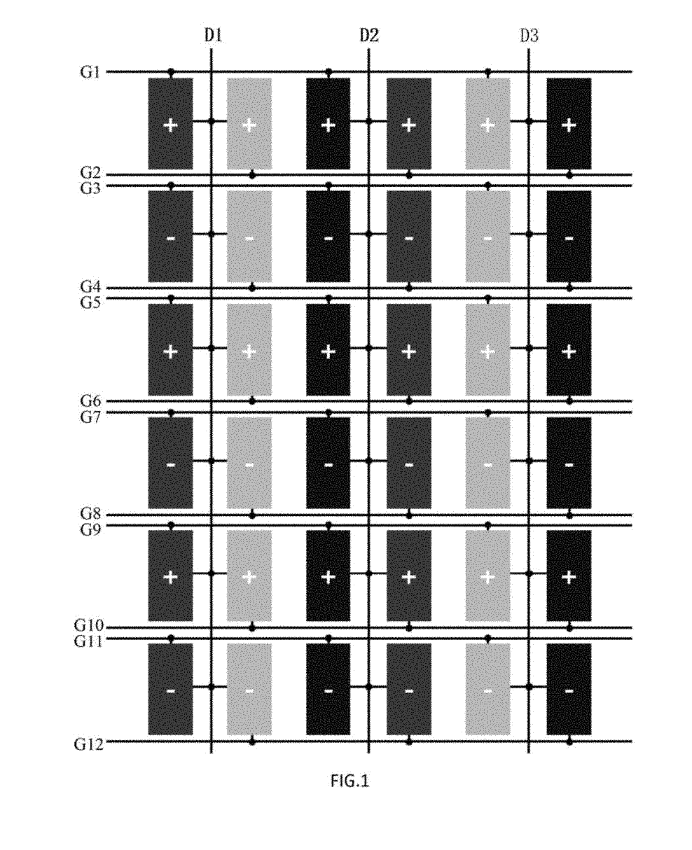

FIG. 2 is the driving clock timing diagram of the liquid crystal display panel of FIG. 1.

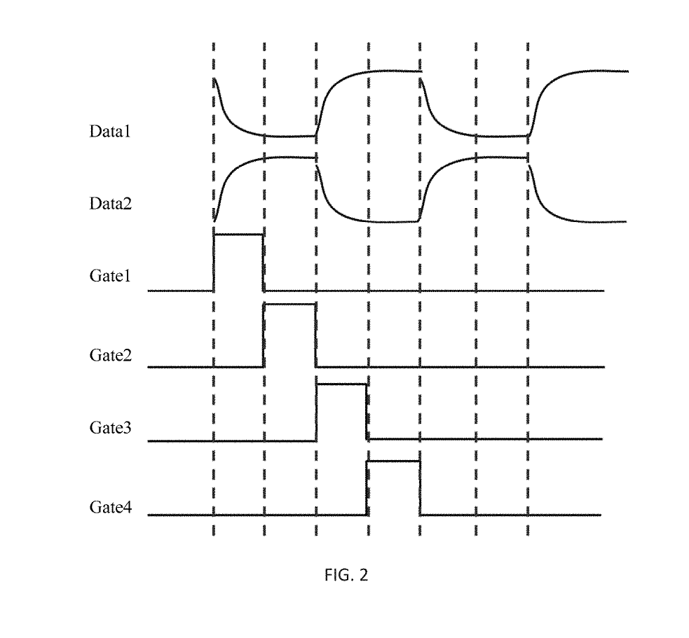

FIG. 3 is the charging efficiency of pixels of the liquid crystal display panel of FIG. 1.

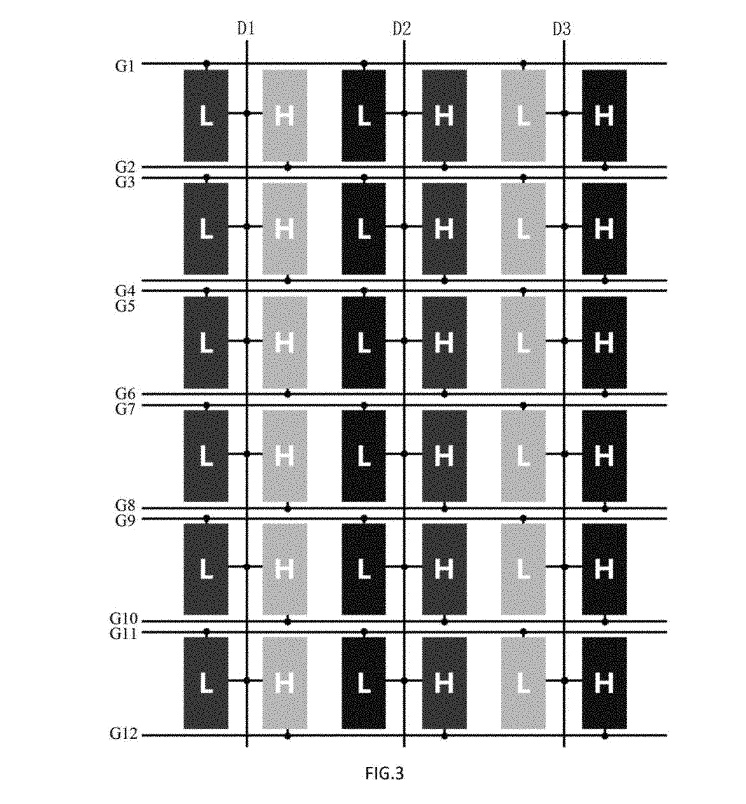

FIG. 4 is the driving structure of the liquid crystal display panel in accordance with a first embodiment.

FIG. 5 is the driving clock timing diagram of the liquid crystal display panel of FIG. 4.

FIG. 6 is the illustrative diagram of charging efficiency of the pixels of the liquid crystal display panel of FIG. 4.

FIG. 7 is the driving structure of the liquid crystal display panel in accordance with a second embodiment.

FIG. 8 is the driving structure of the liquid crystal display panel of FIG. 7.

FIG. 9 is the illustrative diagram of charging efficiency of the pixels of the liquid crystal display panel of FIG. 7.

FIG. 10 is the driving structure of the liquid crystal display panel in accordance with a second embodiment.

FIG. 11 is the driving structure of the liquid crystal display panel of FIG. 10.

FIG. 12 is the illustrative diagram of charging efficiency of the pixels of the liquid crystal display panel of FIG. 10.

FIG. 13 is the driving structure of the liquid crystal display panel in accordance with a second embodiment.

FIG. 14 is the driving structure of the liquid crystal display panel of FIG. 13.

FIG. 15 is the illustrative diagram of charging efficiency of the pixels of the liquid crystal display panel of FIG. 13.

### DETAILED DESCRIPTION OF THE PREFERRED EMBODIMENTS

The embodiments described herein, with reference to the accompanying drawings, are explanatory, illustrative, and used to generally understand the present disclosure. Furthermore, directional terms described by the present disclosure, such as upper, lower, front, rear, left, right, inner, outer, side, etc., are only directions by referring to the accompanying drawings, and thus the used directional terms are used to describe and understand the present disclosure, but the present disclosure is not limited thereto.

In the drawings, modules, parts or components with similar structures are labeled with the same reference number.

In addition, terms such as “first” and “second” are used herein for purposes of description and are not intended to indicate or imply relative importance or significance. In the description of the present disclosure, “a plurality of” relates to two or more than two. Furthermore, the terms “including” and “having” and any deformations thereof are intended to cover non-exclusive inclusion.

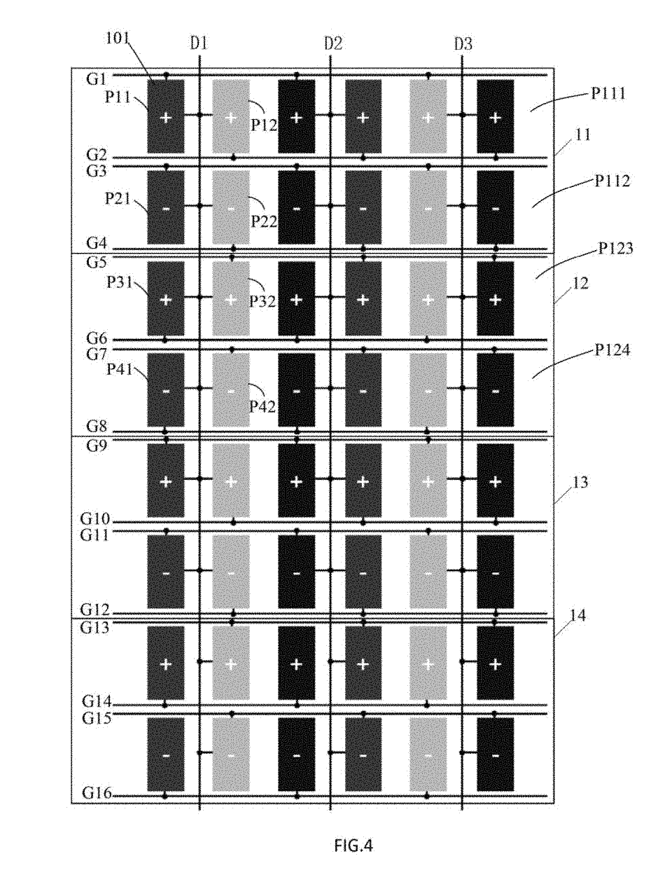

Referring now to FIGS. 4 to 6, particularly to FIG. 4, a driving structure of the liquid crystal display panel in accordance with a first embodiment is illustrated.

In the first embodiment of the present disclosure, the liquid crystal display panel comprises a plurality of scanning lies G1-G16, a plurality of data lines D1-D3, and a plurality of pixels 101. Each line of pixels is correspondingly configured with two scanning lines named the first scanning line and the second scanning line. For example, the first line of pixels as shown at the top of FIG. 4 is correspondingly configured with the first scanning line G1 and the second scanning line G2 at its two sides. Two adjacent rows of pixels are correspondingly configured with a data line therebetween. For example, data line D1 is connected with the first row of pixels and the second row of pixels. Data line D2 is connected with the third row of pixels and the fourth row of pixels. Data line D3 is connected with the fifth row of pixels and the sixth row of pixels.

The liquid crystal display panel of this embodiment comprises four pixel groups 11-14. Each pixel group comprises two lines of pixels which are adjacent to each other in this embodiment. The two lines of pixels may be not adjacent to each other in another embodiment.

The numbered 2k+1 row of pixels of the numbered n pixel group is connected with the corresponding first scanning line. The numbered 2k row of pixels of the numbered n pixel group is connected with the corresponding second scanning line. The numbered 2k+1 row of pixels of the numbered n+1 pixel group is connected with the corresponding second scanning line, The numbered 2k row of pixels of the numbered n pixel group is connected with the corresponding first scanning line, wherein 0<n<N, N≥2, k≥0.

For example, the first pixel group 11 comprises a first line of pixels 111 and a second line of pixels 112. The second pixel group 12 comprises a third line of pixel 123 and a fourth line of pixel 124. Taking the first pixel group 11 and the second pixel group 12 as an example, the pixels in the odd numbered rows are respectively connected with the corresponding first scanning lines G1, G3. The pixels in the even numbered rows are respectively connected with the corresponding second scanning lines G2, G4. More specifically, the odd numbered row pixels in the first line of pixels 111 of the first pixel group 11 are connected with the first scanning line G1, while the even numbered row pixels in the first line of pixels 111 of the first pixel group 11 are connected with the second scanning line G2. More specifically, the odd numbered row pixels in the second line of pixels 112 of the first pixel group 11 are connected with the first scanning line G3, while the even numbered row pixels in the second line of pixels 112 of the first pixel group 11 are connected with the second scanning line G4.

The odd numbered row pixels in the third line and fourth line of pixels 123, 124 of the second pixel group 12 are connected with the second scanning lines G6, G8. The even numbered row pixels in the third line and fourth line of pixels 123, 124 of the second pixel group 12 are connected with the first scanning lines G5, G7. More specifically, the odd numbered row pixels in the third line of pixels 123 of the second pixel group 12 are connected with the second scanning line G6. The even numbered row pixels in the third line of pixels 123 of the second pixel group 12 are connected with the first scanning line G5. The odd numbered row pixels in the fourth line of pixels 124 of the second pixel group 12 are connected with the second scanning line G8. The even numbered row pixels in the fourth line of pixels 124 of the second pixel group 12 are connected with the first scanning line G7.

In another embodiment, the odd numbered row pixels of the first pixel group are connected with the second scanning lines. The even numbered row pixels of the first pixel group are connected with the first scanning lines. The odd numbered row pixels of the second pixel group are connected with the first scanning lines. The even numbered row pixels of the second pixel group are connected with the corresponding second scanning line.

The voltage polarities of two adjacent data lines at the same moment are the same thus causing same voltage polarity for pixels at the same line.

It is understandable, the liquid crystal display panel may comprise two, three, four or even more pixel groups.

Every eight pixels are set as a repeated unit for a same corresponding data line. In FIG. 4, the data line D1 drives its corresponding repeated unit of pixels with a sequence as: P11, P12, P21, P22, P32, P31, P42, P41, wherein the two-digit numbers 11, 12, 21, 22, 32, 31, 42, 41 represent the positions of corresponding pixels in the matrix, the first digit representing the line number, the second digit representing the row number. For example, P11 represents the pixel positioned in the first line and in the first row.

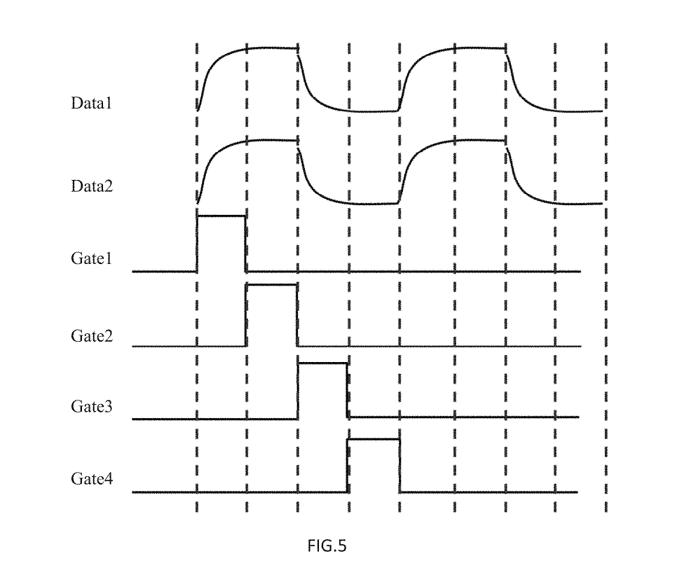

FIG. 5 is the driving clock timing diagram of the liquid crystal display panel of FIG. 4. Data1 represents the input voltage wave of data line D1. Data2 represents the input voltage wave of data line D2. Gate1 represents the input scanning signal wave of the first scanning line G1. Gate2 represents the input scanning signal wave of the second scanning line G2. Gate3 represents the input scanning signal wave of the third scanning line G3. Gate4 represents the input scanning signal wave of the fourth scanning line G4.

The turn-on time of the first scanning line corresponding to each line of pixels is earlier than the turn-on time of the second scanning line corresponding to the same line of pixels. For example, the turn-on time of the first scanning line G1 corresponding to the first line of pixels 111 is earlier than the turn-on time of the second scanning line G2 corresponding to the same line of pixels 111.

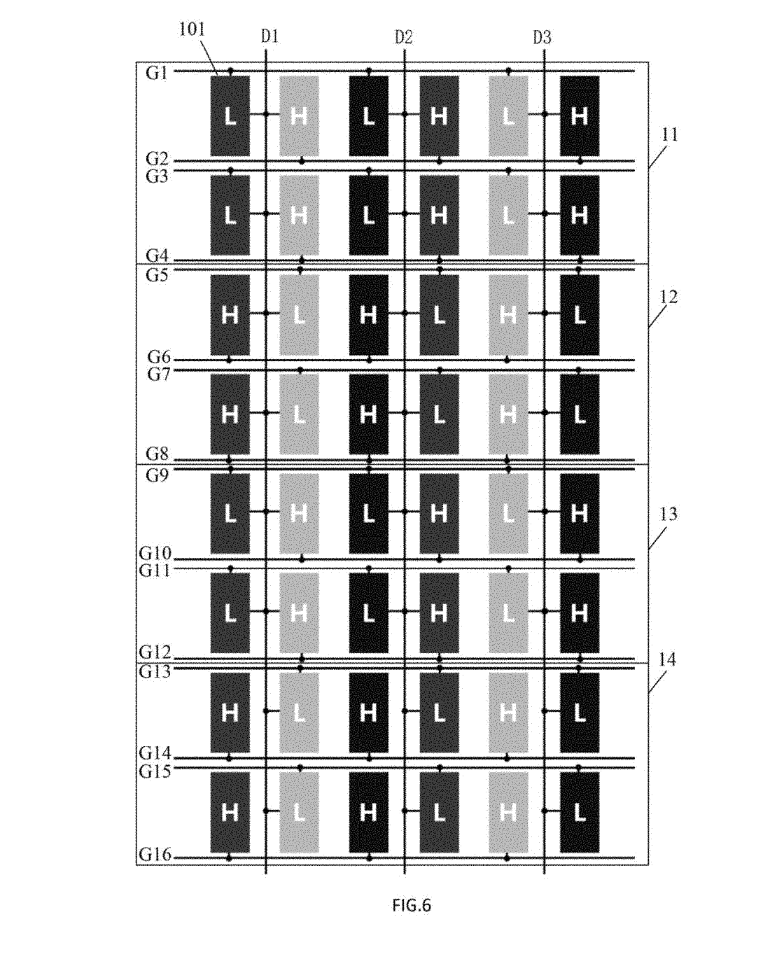

FIG. 6 is the illustrative diagram of charging efficiency of the pixels of the liquid crystal display panel of FIG. 4. “L” represents low charging efficiency, while “H” represents high charging efficiency. From FIG. 6 it can be seen when the voltage polarity of the data line is reversed, the pixels which are driven earlier have low charging efficiency, while the pixels which are driven later have high charging efficiency. In another word, the pixels of each line corresponding to the first scanning line have lower charging efficiency than the other pixels of the same line corresponding to the second scanning line.

All the low charging efficiency pixels may be positioned not in the same row, but in different rows, by using the driving structure of the liquid crystal display panel of FIG. 4. The pixels in numbered n pixel group have different charging efficiency compared to the charging efficiency of the pixels in numbered n+1 pixel group. For example, the pixels of the first pixel group in the first row have different charging efficiency compared to the pixels of the second pixel group in the first row. It may be concluded that the high charging efficiency pixels and the low charging efficiency pixels alternatively positioned in the same row (for example, first row) thereby preventing lighter and darker lines in the vertical direction, thus promoting the displaying effect of the liquid crystal display panel.

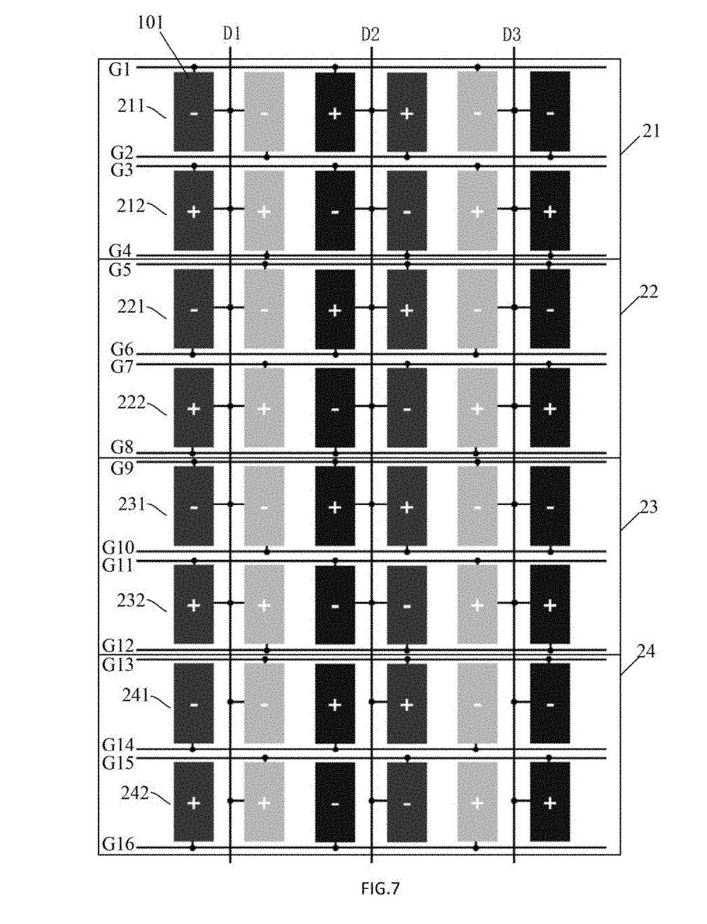

Referring to FIGS. 7-9, FIG. 7 is the driving structure of the liquid crystal display panel in accordance with a second embodiment.

The liquid crystal display panel of the second embodiment also comprises four pixel groups 21-24 and each pixel group 21-24 respectively comprises a first line of pixels 211, 221, 231, 241, and a second line of pixels 212, 222, 232, 242. The driving structure of FIG. 7 is different from the driving structure of FIG. 4 in that the input voltage polarities of the adjacent two data lines are different (FIG. 7) therefore the voltage polarities of pixels of the same line are alternatively changed according to the corresponding data lines. For example, for all the pixels in the first line of pixels 211 of the first pixel group 21: the pixels beside (or adjacent to) the first data line D1 have negative voltage polarity, the pixels beside (or adjacent to) the second data line D2 have positive voltage polarity, and the pixels beside (or adjacent to) the third data line D3 have negative voltage polarity. Therefore, the pixels in each line of the liquid crystal display panel as shown in FIG. 7 not only have high charging efficiency H and low charging efficiency L alternatively positioned, but also have positive voltage polarity and negative voltage polarity alternatively positioned.

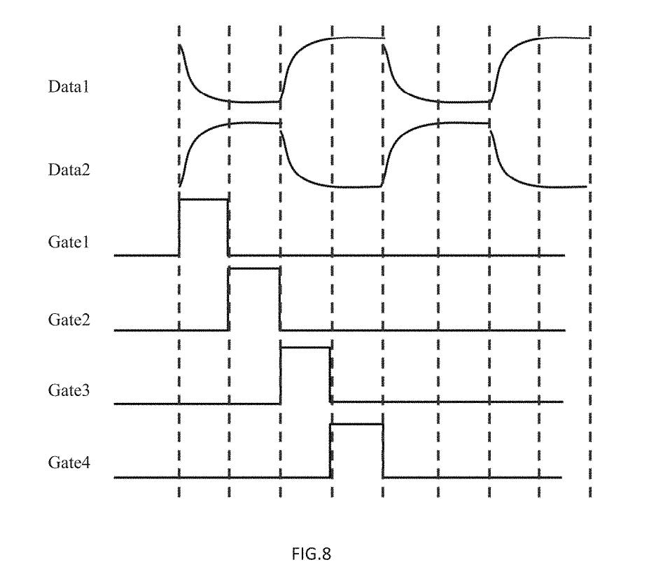

FIG. 8 is the driving structure of the liquid crystal display panel of FIG. 7. Data1 represents the input voltage wave of data line D1. Data2 represents the input voltage wave of data line D2. Gate1 represents the input scanning signal wave of the first scanning line G1. Gate2 represents the input scanning signal wave of the second scanning line G2. Gate3 represents the input scanning signal wave of the third scanning line G3. Gate4 represents the input scanning signal wave of the fourth scanning line G4.

The turn-on time of the first scanning line corresponding to each line of pixels is earlier than the turn-on time of the second scanning line corresponding to the same line of pixels. For example, the turn-on time of the pixels of the first line of pixels 211 of the first pixel group 21 corresponding to the first scanning line G1 is earlier than the turn-on time of the other pixels of the first line of pixels 211 of the first pixel group 21 corresponding to the second scanning line G2.

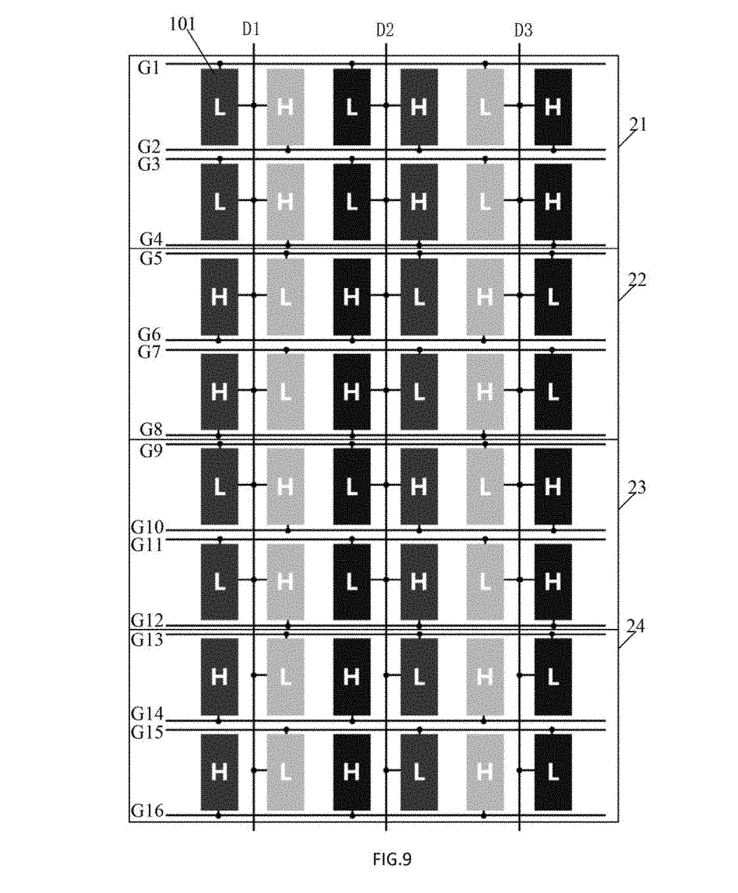

FIG. 9 is the illustrative diagram of charging efficiency of the pixels of the liquid crystal display panel of FIG. 7. “L” represents low charging efficiency, while “H” represents high charging efficiency. From FIG. 9 it can be seen when the voltage polarity of the data line is reversed, the pixels which are driven earlier have low charging efficiency, while the pixels which are driven later have high charging efficiency. In other words, the pixels of each line corresponding to the first scanning line have lower charging efficiency than the other pixels of the same line corresponding to the second scanning line. Using the driving structure of the liquid crystal display panel as shown in FIG. 7, each row of pixels may contain both low charging efficiency pixels and high charging efficiency pixels. In other words, all the low charging efficiency pixels are not positioned in the same row. The charging efficiency of numbered n pixel group in each row of pixels is different from the charging efficiency of numbered n+1 pixel group in said row of pixels. In other words, the pixels with high charging efficiency H and the pixels with low charging efficiency L are alternatively positioned in each row thus preventing generating lighter and darker rows vertically and promoting the displaying effect.

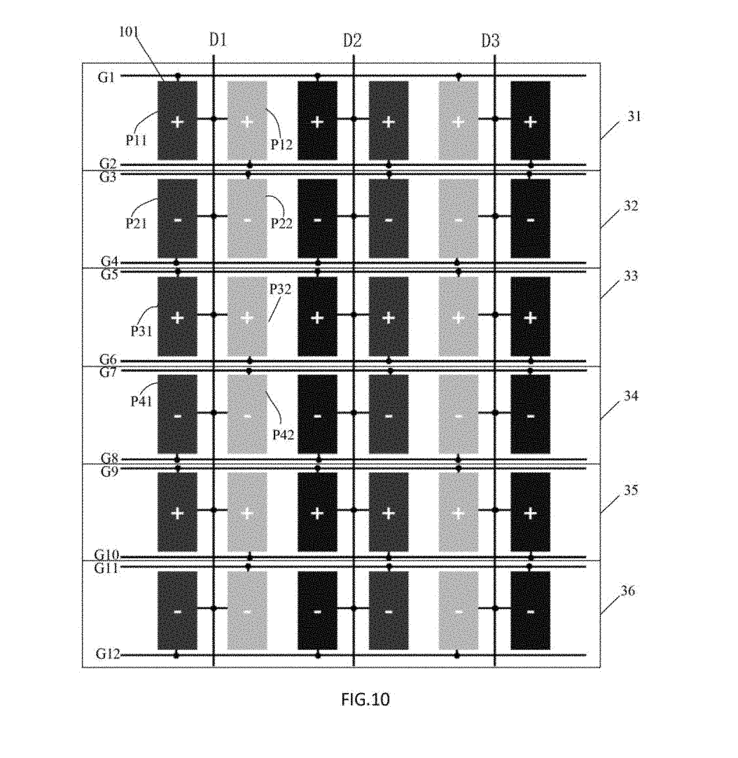

Referring to FIGS. 10-12, FIG. 10 is the driving structure of the liquid crystal display panel in accordance with a third embodiment of the present invention.

The liquid crystal display panel of the present embodiment is different from the liquid crystal display panel of the first embodiment in that the liquid crystal display panel comprises six pixel groups 31-36, each of which comprises a line of pixels. The odd numbered 2k+1 row of pixels of the numbered n pixel group is connected with the corresponding first scanning line. The numbered 2k row of pixels of the numbered n pixel group is connected with the corresponding second scanning line. The numbered 2k+1 row of pixels of the numbered n+1 pixel group is connected with the corresponding second scanning line, The even numbered 2k row of pixels of the numbered n pixel group is connected with the corresponding first scanning line, wherein 0<n<N, N≥2, k≥0.

For example, the first pixel group 31 comprises the first line of pixels. The second pixel group 32 comprises the second line of pixels. Taking the first pixel group 31 and the second pixel group 32 as an example, the pixels of odd numbered row of the first pixel group 31 are connected with the corresponding first scanning line G1, while the pixels of even numbered row are connected with the corresponding second scanning line G2. The pixels of odd numbered row of the second pixel group 32 are connected with the corresponding second scanning line G4, while the pixels of even numbered row are connected with the corresponding first scanning line G3. Other pixel groups 33-36 are similar to the first and second pixel groups as shown in FIG. 10.

Every eight pixels are set as a repeated unit for a same corresponding data line. In FIG. 10, the data line D1 drives its corresponding repeated unit of pixels with a sequence as:

P11, P12, P21, P22, P32, P31, P42, P41, wherein the two-digit numbers 11, 12, 21, 22, 32, 31, 42, 41 each respectively represent the positions of corresponding pixels in the matrix, the first digit representing the line number of the pixel, the second digit representing the row number of the pixel. For example, P11 represents the pixel positioned in the first line and in the first row.

Every two adjacent data lines as shown in this embodiment have the same input data voltage polarity, therefore the pixels in the same line have the same voltage polarity.

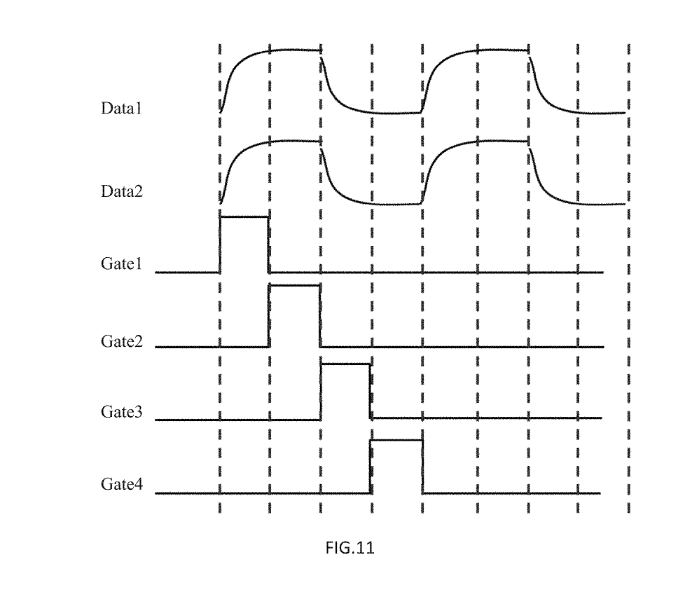

FIG. 11 is the driving clock timing diagram of the liquid crystal display panel of FIG. 10. Data1 represents the input voltage wave of data line D1. Data2 represents the input voltage wave of data line D2. Gate1 represents the input scanning signal wave of the first scanning line G1. Gate2 represents the input scanning signal wave of the second scanning line G2. Gate3 represents the input scanning signal wave of the third scanning line G3. Gate4 represents the input scanning signal wave of the fourth scanning line G4.

The turn-on time of the first scanning line corresponding to each line of pixels is earlier than the turn-on time of the second scanning line corresponding to the same line of pixels. For example, the turn-on time of the first scanning line G1 corresponding to the first line of pixels 31 is earlier than the turn-on time of the second scanning line G2 corresponding to the same line of pixels 31.

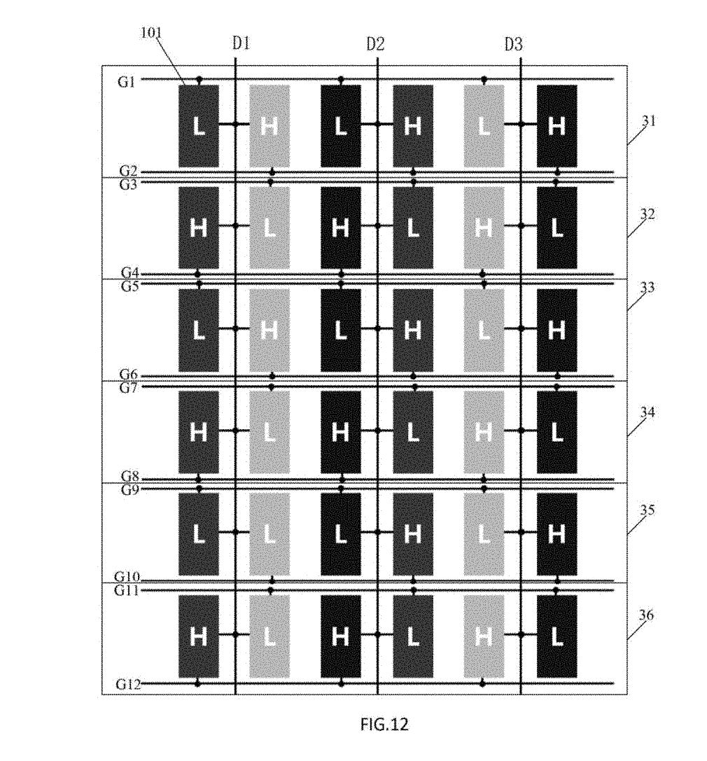

FIG. 12 is the illustrative diagram of charging efficiency of the pixels of the liquid crystal display panel of FIG. 10. “L” represents low charging efficiency, while “H” represents high charging efficiency. From FIG. 12 it can be seen when the voltage polarity of the data line is reversed, the pixels which are driven earlier have low charging efficiency, while the pixels which are driven later have high charging efficiency. All the low charging efficiency pixels may be positioned not in the same row, but in different rows, by using the driving structure of the liquid crystal display panel of FIG. 10. In other words, the pixels of each line corresponding to the first scanning line G1 have lower charging efficiency than the other pixels of the same line corresponding to the second scanning line G2. The pixel of each row positioned in numbered n pixel group has different charging efficiency compared to the charging efficiency of the pixel of the same row positioned in numbered n+1 pixel group. For example, the pixel P11 of the first pixel group 31 in the first row has different charging efficiency compared to the pixel P21 of the second pixel group 32 in the first row. It may be concluded that the high charging efficiency pixels and the low charging efficiency pixels alternatively positioned in the same row (for example, the first row) thereby preventing lighter and darker lines in the vertical direction, thus promoting the displaying effect of the liquid crystal display panel.

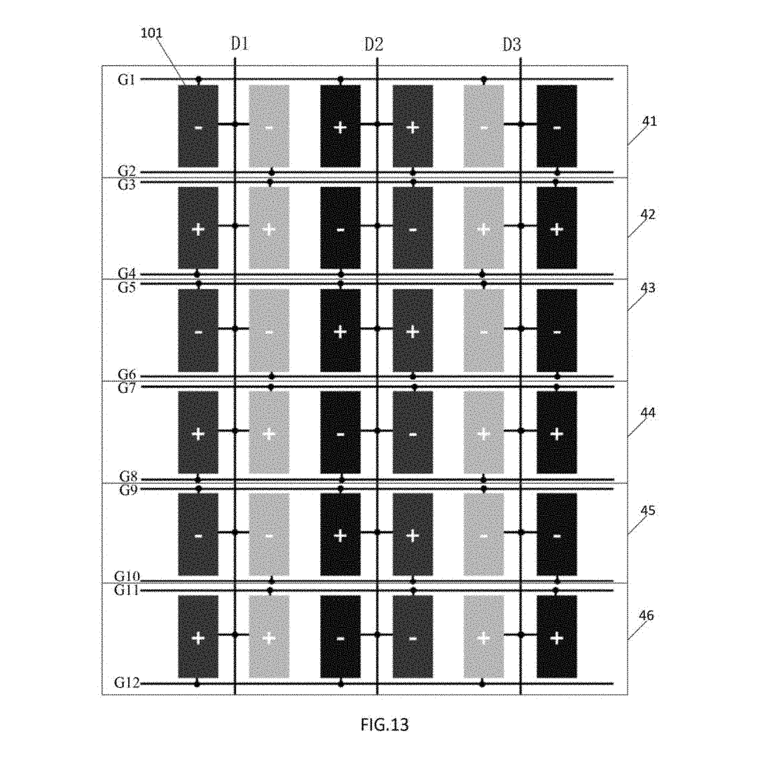

Referring to FIGS. 13-15, FIG. 13 is the driving structure of the liquid crystal display panel in accordance with a fourth embodiment of the present invention.

The liquid crystal display panel of the present embodiment comprises six pixel groups 41-46. The driving structure of FIG. 13 is different from the driving structure of FIG. 10 in that the input voltage polarities of the adjacent two data lines are different (FIG. 13) therefore the voltage polarities of pixels of the same line are alternatively changed according to the corresponding data lines. For example, for all the pixels in the first line of pixels 41 (i.e., the first pixel group 41): the pixels beside (or adjacent to) the first data line D1 have negative voltage polarity, the pixels beside (or adjacent to) the second data line D2 have positive voltage polarity, and the pixels beside (or adjacent to) the third data line D3 have negative voltage polarity. Therefore, the pixels in each line of the liquid crystal display panel as shown in FIG. 13 not only have high charging efficiency H and low charging efficiency L alternatively positioned, but also have positive voltage polarity and negative voltage polarity alternatively positioned.

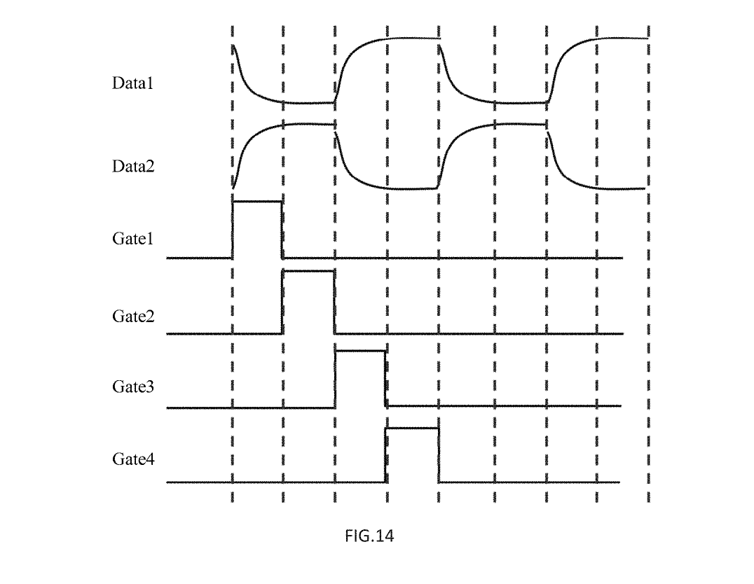

FIG. 14 is the driving clock timing diagram of the liquid crystal display panel of FIG. 13. Data1 represents the input voltage wave of data line D1. Data2 represents the input voltage wave of data line D2. Gate1 represents the input scanning signal wave of the first scanning line G1. Gate2 represents the input scanning signal wave of the second scanning line G2. Gate3 represents the input scanning signal wave of the third scanning line G3. Gate4 represents the input scanning signal wave of the fourth scanning line G4.

The turn-on time of the first scanning line corresponding to each line of pixels is earlier than the turn-on time of the second scanning line corresponding to the same line of pixels. For example, the turn-on time of the first scanning line G1 corresponding to the first line of pixels 41 is earlier than the turn-on time of the second scanning line G2 corresponding to the same line of pixels 41.

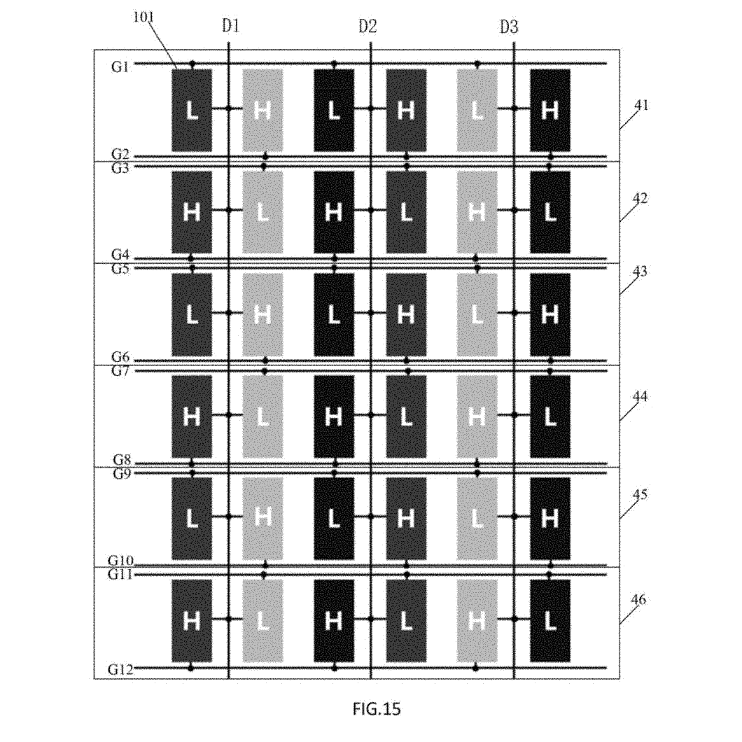

FIG. 15 is the illustrative diagram of charging efficiency of the pixels of the liquid crystal display panel of FIG. 13. “L” represents low charging efficiency, while “H” represents high charging efficiency. From FIG. 15 it can be seen when the voltage polarity of the data line is reversed, the pixels which are driven earlier have low charging efficiency, while the pixels which are driven later have high charging efficiency. All the low charging efficiency pixels may be positioned not in the same row, but in different rows, by using the driving structure of the liquid crystal display panel of FIG. 13. In other words, the pixels of each line corresponding to the first scanning line G1 have lower charging efficiency than the other pixels of the same line corresponding to the second scanning line G2. All the low charging efficiency pixels may be positioned not in the same row, but in different rows, by using the driving structure of the liquid crystal display panel of FIG. 13. The pixel of each row positioned in numbered n pixel group has different charging efficiency compared to the charging efficiency of the pixel of the same row positioned in numbered n+1 pixel group. For example, the pixel P11 of the first pixel group 41 in the first row has different charging efficiency compared to the pixel P21 of the second pixel group 42 in the first row. It may be concluded that the high charging efficiency pixels and the low charging efficiency pixels alternatively positioned in the same row (for example, the first row) thereby preventing lighter and darker lines in the vertical direction, thus promoting the displaying effect of the liquid crystal display panel.

The liquid crystal display panel and device of the present invention comprises a plurality of pixels which are classified into pixel groups, each of which comprises at least one line of pixels. Pixels in the same row of adjacent two pixel groups are connected with scanning lines having different driving time thus causing different charging efficiencies therebetween, preventing lighter and darker lines from generating in the vertical direction, thus promoting displaying effect.

The present disclosure has been described with a preferred embodiment thereof. The preferred embodiment is not intended to limit the present disclosure, and it is understood that many changes and modifications to the described embodiment can be carried out without departing from the scope and the spirit of the invention that is intended to be limited only by the appended claims.

What is claimed is:

1. A liquid crystal display panel, wherein the liquid crystal display panel comprises a plurality of scanning lines, a plurality of data lines, and a plurality of pixels, each line of pixels being corresponding to a first scanning line and a second scanning line of the scanning lines, every two rows of pixels being corresponding to one of the data lines;
wherein the liquid crystal display panel further comprises N number of pixel groups, each of which comprises at least one line of pixels, wherein the 2k+1 row of pixels of the numbered n pixel group is connected with the corresponding first scanning line, wherein the numbered 2k row of pixels of the numbered n pixel group is connected with the corresponding second scanning line;
wherein the 2k+1 row of pixels of the numbered n+1 pixel group is connected with the corresponding second scanning line, wherein the numbered 2k row of pixels of the numbered n pixel group is connected with the corresponding first scanning line, wherein 0<n<N, N [symbol] , k [symbol] ;
wherein the turn-on time of the first scanning line corresponding to each line of pixels is earlier than the turn-on time of the second scanning line of said line of pixels, wherein the charging efficiency of pixels corresponding to the first scanning line is lower than the charging efficiency of pixels corresponding to the second scanning line; the charging efficiency of the numbered n pixel group in each row of pixels is different from the charging efficiency of the numbered n+1 pixel group in said row of pixels.

2. The liquid crystal display panel according to claim 1, wherein the voltage polarities of two adjacent two data lines at the same moment are the same.

3. The liquid crystal display panel according to claim 1, wherein the voltage polarities of two adjacent data lines at the same moment are different.

4. The liquid crystal display panel according to claim 1, wherein the pixel group comprises two lines of pixels; wherein the numbered 2k+1 row of pixels of the numbered n pixel group is connected with the corresponding first scanning line, wherein the numbered 2k row of pixels of the numbered n pixel group is connected with the corresponding second scanning line;
wherein the numbered 2k+1 row of pixels of the numbered n+1 pixel group is connected with the corresponding second scanning line, wherein the numbered 2k row of pixels of the numbered n+1 pixel group is connected with the corresponding first scanning line,

5. The liquid crystal display panel according to claim 4, wherein the pixel group comprises two adjacent lines of pixels.

6. A liquid crystal display panel, wherein the liquid display panel comprises a plurality of scanning lines, a plurality of data lines, and a plurality of pixels, each line of pixels being corresponding to a first scanning line and a second scanning line of the scanning lines, every two rows of pixels being corresponding to one of the data lines;
wherein the liquid display panel further comprises N number of pixel groups, each of which comprises at least one line of pixels, wherein the 2k+1 row of pixels of the numbered n pixel group is connected with the corresponding first scanning line, wherein the numbered 2k row of pixels of the numbered n pixel group is connected with the corresponding second scanning line;
wherein the 2k+1 row of pixels of the numbered n+1 pixel group is connected with the corresponding second scanning line, wherein the numbered 2k row of pixels of the numbered n pixel group is connected with the corresponding first scanning line, wherein 0<n<N, N [symbol] , k [symbol] .

7. The liquid crystal display panel according to claim 6, wherein the voltage polarities of two adjacent two data lines at the same moment are the same.

8. The liquid crystal display panel according to claim 6, wherein the voltage polarities of two adjacent two data lines at the same moment are different.

9. The liquid crystal display panel according to claim 6, wherein the charging efficiency of numbered n pixel group in each row of pixels is different from the charging efficiency of numbered n+1 pixel group in said row of pixels.

10. The liquid crystal display panel according to claim 6, wherein the turn-on time of the first scanning line corresponding to each line of pixels is earlier than the turn-on time of the second scanning line of said line of pixels, wherein the charging efficiency of pixels corresponding to the first scanning line is lower than the charging efficiency of pixels corresponding to the second scanning line.

11. The liquid crystal display panel according to claim 6, wherein the pixel group comprises two lines of pixels; wherein the 2k+1 row of pixels of the numbered n pixel group is connected with the corresponding first scanning line, wherein the numbered 2k row of pixels of the numbered n pixel group is connected with the corresponding second scanning line;
wherein the 2k+1 row of pixels of the numbered n+1 pixel group is connected with the corresponding second scanning line, wherein the numbered 2k row of pixels of the numbered n pixel group is connected with the corresponding first scanning line,

12. The liquid crystal display panel according to claim 11, wherein the pixel group comprises two adjacent lines of pixels.

13. A liquid crystal display device, wherein the liquid crystal display device comprises: a backlight module and a liquid crystal display panel which comprises a plurality of scanning lines, a plurality of data lines, and a plurality of pixels, each line of pixels being corresponding to a first scanning line and a second scanning line of the scanning lines, every two raws of pixels being corresponding to one of the data lines;
wherein the liquid display panel further comprises N number of pixel groups, each of which comprises at least one line of pixels, wherein the 2k+1 row of pixels of the numbered n pixel group is connected with the corresponding first scanning line, wherein the numbered 2k row of pixels of the numbered n pixel group is connected with the corresponding second scanning line;
wherein the 2k+1 row of pixels of the numbered n+1 pixel group is connected with the corresponding second scanning line, wherein the numbered 2k row of pixels of the numbered n pixel group is connected with the corresponding first scanning line, wherein 0<n<N, N [symbol] , k [symbol] .

14. The liquid crystal display device according to claim 13, wherein the voltage polarities of two adjacent data lines at the same moment are the same.

15. The liquid crystal display device according to claim 13, wherein the voltage polarities of two adjacent data lines at the same moment are different.

16. The liquid crystal display device according to claim 13, wherein the charging efficiency of numbered n pixel group in each row of pixels is different from the charging efficiency of numbered n+1 pixel group in said row of pixels.

17. The liquid crystal display device according to claim 13, wherein the turn-on time of the first scanning line corresponding to each line of pixels is earlier than the turn-on time of the second scanning line of said line of pixels, wherein the charging efficiency of pixels corresponding to the first scanning line is lower than the charging efficiency of pixels corresponding to the second scanning line.

18. The liquid crystal display device according to claim 13, wherein the pixel group comprises two lines of pixels; wherein the numbered 2k+1 row of pixels of the numbered n pixel group is connected with the corresponding first scanning line, wherein the numbered 2k row of pixels of the numbered n pixel group is connected with the corresponding second scanning line;
wherein the numbered 2k+1 row of pixels of the numbered n+1 pixel group is connected with the corresponding second scanning line, wherein the numbered 2k row of pixels of the numbered n pixel group is connected with the corresponding first scanning line.

19. The liquid crystal display device according to claim 18, wherein the pixel group comprises two adjacent lines of pixels.
